(19) United States
(12) Patent Application Publication
(10) Pub. No.: US 2014/0093834 A1
(43) Pub. Date: Apr. 3, 2014

(54) Repositioning Appliance

(71) Applicant: Joseph Youssif Andary, Burlington (CA)

(72) Inventor: Joseph Youssif Andary, Burlington (CA)

(21) Appl. No.: 14/040,453

(22) Filed: Sep. 27, 2013

Related U.S. Application Data
(60) Provisional application No. 61/707,728, filed on Sep. 28, 2012.

(51) Int. Cl. A61C 7/08

(52) U.S. Cl. CPC A61C 7/08
USPC 433/6; 433/24

(57) ABSTRACT

A mandible repositioning appliance is provided comprising an anterior member adapted to receive anterior teeth; first and second posterior members, each adapted to receive posterior teeth, wherein each posterior member comprises an occlusal pad support; and a positioning guide formed between the anterior member and each of the first and second posterior members, wherein said guide functions to position the user's mandible into an anatomically correct position achieved when each positioning guide is in position resting between the third and fourth upper and lower anterior teeth when the appliance is in place in the user's mouth.

### PRIORITY CLAIM

This application claims priority to and the benefit of U.S. Provisional Patent Application 61/707,728 filed on Sep. 28, 2012 entitled REPOSITIONING APPLIANCE.

### FIELD OF THE INVENTION

The present invention relates to an oral appliance useful to position, stabilize and capture the correct anatomical position of the lower jaw relative to the upper jaw using various techniques.

### BACKGROUND OF THE INVENTION

The temporomandibular joint is the joint of the jaw and is frequently referred to as TMJ. There are two TMJs, one on each side, working in unison to effect movement of the jaw, which is medically referred to as the mandible. FIG. 4A shows the general structure of the jaw and its alignment. The term TMJ 4 is derived from the two bones which form the joint: the upper temporal bone 3 (fossa) which is part of the cranium (skull), and the lower jaw bone called the mandible 5. The unique feature of the TMJs is the articular disc 1. The disc is composed of fibrocartilagenous tissue which is positioned between the two bones (fossa 3 and mandible 5) that form the joint and is attached to the posterior wall of the fossa by a loose connective tissue known as the retrodiscal tissue 6. The disc 1 divides each joint into two movable parts. The lower joint compartment formed by the mandible 5 and the articular disc 1 is involved in rotational movement—this is the initial movement of the jaw when the mouth opens. The upper joint compartment formed by the articular disc 1 and the temporal bone 3 is involved in translational movement—this is the secondary gliding motion of the jaw as it is opened widely. The part of the mandible 5 which mates to the under-surface of the disc is the condyle 2 and the part of the temporal bone which mates to the upper surface of the disc 1 is the glenoid (or mandibular) fossa 3.

The temporomandibular joint (TMJ) movably connects the upper jaw or maxilla 7 and the lower jaw or mandible 5. The TMJ 4 essentially consists of the condyle 2 of the lower jaw, the articular disc 1 and the glenoid fossa 3 of the upper jaw's temporal bone 7. The condyle 2 of the lower jaw sits within the glenoid fossa 3. The temporomandibular joint 4 is sometimes referred to as a “Dynamic Sling”. There are various condylar positions within the glenoid fossa 3, including the centric occlusion position, the myocentric contact position, the habitual rest position, the physiological resting position and maximum opening. The mandible typically opens and closes on a habitual trajectory determined by the existing position of the teeth in both corresponding arches and proprioreceptive neural programming of the surrounding musculature. The trajectory can be influenced by various deprogramming methods such as the use of TENS (Myomonitor low—frequency Trans Electrical Neural Stimulation) or an Aqualizer to create a myocentric trajectory pathway. The centric occlusion position or accommodative position can be defined as the position in which the teeth 8 are in maximum intercuspation with the mandible closing along a habitual trajectory pathway. The centric occlusion position may or may not coincide with the myocentric or physiological occlusal contact position. The physiological occlusal resting position can be defined as the position of the mandible when at rest, with the condyles 2 in a neutral, unstrained position in the glenoid fossa 3. Physiological rest recognizes that the articular discs 1 must be properly aligned/positioned over the condylar head 2 to prevent intrusion and compression to the retro discal tissue during function or at rest. Physiological rest recognizes that the condyle 2 is not positioned posterior and superiorly within the glenoid fossa 3 but rather in a state of decompression as opposed to a state of compression. The physiological occlusal contact position or myocentic occlusion can be achieved by eliminating occlusal interferences through the use of various bite registration materials and or using muscle deprogramming to create an isotonic closure of the mandible 6 on a myocentric trajectory. The myocentric position is a terminal point along the myocentric trajectory at which occlusal contact can occur between opposing teeth in the natural dentition or in a bite registration (record) type material. Myocentric occlusion may be defined as a position in which the muscles move the mandible from a non-torqued rest position into full occlusion with minimal muscle accommodation and no interferences of occlusal contacts until full closure is attained thus eliminating torque during closure

A large percentage of the population, e.g. 80-90% of the population, have some form of temporomandibular joint dysfunction or TMD. The most frequent structural causes of TMD are internal derangements which involve progressive slipping or displacement of a component of the temporomandibular joint called the articular disc. The disc is composed of fibrocartilagenous tissue located between the condyle and the fossa of the joint whose movement is controlled by muscles. The disc separates the bones in the joint, preventing them from rubbing together and allows the joint to move smoothly. If the disc slips out of place or is displaced, it can prevent the proper functional movement of the condyle and cause dysfunction. The disc can degenerate, becoming misshapen or even torn. Because the deranged joint will continue to try and function, even in an impaired manner, internal derangement disorders often get worse with time.

Tearing or stretching of the ligaments holding the disc in place often causes an internal derangement. This condition can be caused by an acute trauma such as a blow to the jaw. It may also be caused by more chronic, micro trauma, wear on the joint such as from bruxism, a bad bite (malocclusion) or repeated excessive jaw movements. There are two types of soft tissue derangements. An internal derangement with reduction occurs when the disc slides into and out of its normal functional position as the jaw opens and closes, causing a popping sound characteristic of TMD. Internal derangement without reduction occurs when the disc is permanently displaced or dislocated to an incorrect position causing the jaw's range of motion to be limited and asymmetrical. These derangements can be affected by devices placed between the occlusal surfaces of the teeth. In most cases these derangements can be corrected by these devices which allow proper functioning of the TMJ joint. In many individuals, a downward and forward advancement of the lower jaw, repositions the condyles on the articular disc (i.e. known as “reducing the disc”) which leads to a more relaxed musculature and calming of the entire trigeminal system. In such repositioning, it is important to balance the occlusion i.e., the contact areas of the teeth, on the appliance itself or during the bite taking process, bilaterally and eliminate occlusal interferences. Balancing contacts bilaterally as well as eliminating occlusal interferences eliminates torque in the mandible and unwanted muscle activity and neuromuscular responses. In turn, relaxed musculature allows for the correction of head posture, neck and shoulder posture and relaxation of the airway and surrounding jaw and neck musculature. Just as important is the unstrained neutral position of the condyles relative to the articular disc 1 and the temporomandibular fossa 3 in a physiological functional and anatomically correct position.

Mandibular repositioning devices are known in the art. For example, U.S. Pat. No. 6,935,857 teaches one such repositioning device comprising an asymmetrical aerofoil shape which supports the jaw of a user and encourages the lower jaw to assume its anatomically correct position relative to the upper jaw, believed to result in relaxation of muscles in the head and neck, and a jaw position that is resistant to injury, improves athletic performance and increases air flow.

However, it would be desirable to develop additional devices that aim to achieve an improved positioning of the lower jaw relative to the upper jaw.

### SUMMARY OF THE INVENTION

A novel mandibular repositioning appliance has now been developed and is disclosed herein that is adapted to position the lower jaw into an anatomically correct position relative to the upper jaw. The correct anatomical position is a position that allows an optimal mandibular opening and closing path in which the muscles of mastication and postural muscles of the head and neck are in harmony with one another, such as the muscles are relaxed and TMJ tensions are minimized. The articular discs are properly aligned/positioned over the condylar head (not anterior or medially displaced) to prevent intrusion onto the retro-discal tissue during function. The condyles are not positioned in a posterior superior position within the glenoid fossa, but rather in a state of decompression and not compression. The condyles and discs function freely of any impingement (no clicking, no popping).

In one embodiment of the invention, a mandible repositioning appliance for use to reposition the mandible of a user is provided. The repositioning appliance comprising an anterior portion adapted to receive anterior teeth, such that the anterior portion which is buccal to the lower anterior teeth is notched to provide frenum relief from impingement. As part of the appliance is a first and second posterior portions connected by the anterior portion, such that the first and second posterior portions are adapted to receive posterior teeth, wherein each posterior portion may comprises an adaptable occlusal pad support. This embodiment also includes a positioning guide formed between the anterior portion and each of the first and second posterior portions, The guide functions to position the user's mandible into an anatomically correct position and is achieved when each positioning guide is in position resting between the cuspids teeth (numerically identified as teeth 13, 23, 33 and 43 using the Palmer System and teeth 6, 11, 22 and 27 using the Universal System) and the first bicuspids (14, 24, 34 and 44 using the Palmer System) or teeth 5, 12, 21 and 28 using the Universal System) of both the upper and lower teeth when the appliance is in place in the user's mouth. The positioning guide also prevents the upper teeth from coming into contact with the lower teeth during the repositioning and bite taking process.

In one embodiment the appliance further comprising a registration material on the first and second posterior portions. In one configuration the registration material is on the occlusal pad support of each posterior portion. In one embodiment the occlusal pad support is formed from or made of a registration material. The registration material may be molded by application of heat which softens the registration material. In one configuration the positioning guide has a height which separates the upper and lower anterior teeth. A shelf may extend from the occlusal pad support.

In another aspect, a kit is provided that is useful for mandibular repositioning. The kit may comprise of a mandible repositioning appliance comprising an anterior portion adapted to receive anterior teeth and a first and second posterior portion each adapted to receive posterior teeth. In this embodiment each posterior portion comprises an occlusal pad support but not in all embodiments. Also part of the kit is a positioning guide formed between the anterior portion and each of the first and second posterior portions, such that the guide functions to position the user's mandible into an anatomically correct position achieved when each positioning guide is in position resting between the cuspids teeth 13, 23, 33 and 43 (Palmer System) 6, 11, 22 and 27 (Universal System) and first bicuspids the cuspids teeth 13, 23, 33 and 43 (Palmer System) 6, 11, 22 and 27 (Universal System) and first bicuspids 14, 24, 34 and 44 (Palmer System) 5, 12, 21 and 28 (Universal System)of both the upper and lower teeth and prevent the upper and lower teeth from touching each other when the appliance is in place in the user's mouth. Registration material is provided for use in making an occlusal pad in each occlusal pad support.

In one embodiment the occlusal pad support includes a mesh or a plurality of apertures configured to hold the registration material when the registration material is applied to the occlusal pad support. In one configuration, the positioning guide, which is cylindrical in shape, is associated with each occlusal pad support and extends across each occlusal pad support. It is contemplated that a size be associated with the kit and the size corresponds to the size of the appliance, to thereby adapt the kit to the position of the patient's mandible.

In a further aspect, a method of making a mandible repositioning appliance as described above is provided that comprises applying a biocompatible registration material to the occlusal pad supports of the first and second posterior portions of the appliance. The method also includes placing the appliance in position in a user's mouth wherein the positioning guides are seated between the cuspids teeth 33 and 43 in the Palmer System or 22 and 27 in the Universal System and first bicuspids of the lower teeth, 34 and 44 in the Palmer System 21 and 28 in the Universal System, and then having the user to close their mandible such that the positioning guides are enclosed within the space between the cuspids teeth 13, 23, 33 and 43 in the Palmer System or teeth 6, 11, 22 and 27 in the Universal System and first bicuspids 14, 24, 34 and 44 in the Palmer System and 5, 12, 21 and 28 in the Universal System of both the upper and lower teeth. and then holding the appliance until the registration material sets to form occlusal pads in the posterior portions. The appliance may then be removed for further processing, or used as formed.

Various methods for deprogramming the muscles that control the movement of the mandible and the articular disc can be employed if necessary prior or during closure of the mandible onto the occlusal pads.

In a further aspect, a method of making a mandibular repositioning device as described may include that the posterior occlusal pads are preheated in water 130 C to 160 C, and then placing the appliance in position in a user's mouth wherein the positioning guides are seated between the cuspids teeth 33 and 43 in the Palmer System 22 and 27 in the Universal System and first bicuspids 34 and 44 in the Palmer System or 21 and 28 in the Universal System) of the lower teeth. The method would then include having the user to close their mandible such that the positioning guides are enclosed within the space between the cuspids, teeth 13, 23, 33 and 43 in the Palmer System or teeth 6, 11, 22 and 27 in the Universal System and first bicuspids 14, 24, 34 and 44 in the Palmer System and teeth 5, 12, 21 and 28 in the Universal System of both the upper and lower teeth.

Various methods for deprogramming the muscles that control the movement of the mandible and the articular disc can be employed if necessary prior or during closure of the mandible onto the occlusal pads.

In one embodiment, moving the user's mandible toward the user's upper jaw is done by the user or by a dental technician. Providing an appliance with the registration material may include applying a registration material to the first and second occlusal pad supports of the first and second posterior portions of the appliance, such that the registration material is mixed or extruded from one or more tubes. Or, the step of providing an appliance with the registration material comprises heating the registration material to soften the registration material. Thereafter, the user may drink cold liquid to set the registration material when maintaining position of the user's mandible. The user or dental technician may move the user's mandible to verify the reproducibility of a fitment and if necessary reheat the registration material and repeat the process. It is also contemplated that the appliance may further comprise a curved opening in the anterior connector and the method further comprises providing registration material in the anterior connector such that movement of the user's mandible causes one or more anterior teeth of the user to contact and mold the registration material in the anterior connector.

These and other aspects of the invention will become apparent from the detailed description and by reference to the drawings. Likewise, other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views;

FIG. 1 is a perspective view of a mandible repositioning apparatus for use on the lower jaw of a user in accordance with an aspect of the invention;

FIG. 2A is a side view of one possible embodiment of the mandible repositioning apparatus for use on the upper jaw of a user in accordance with an aspect of the invention;

FIG. 2B is a front view of one possible embodiment of the mandible repositioning apparatus for use on the upper jaw of a user in accordance with an aspect of the invention;

FIG. 2C is a top plan view of one possible embodiment of the mandible repositioning apparatus for use on the upper jaw of a user in accordance with an aspect of the invention;

FIG. 3A is a side perspective view of a lower mandible repositioning appliance;

FIG. 3B is a top plan view of a lower mandible repositioning appliance;

FIG. 4A is a side view of upper and lower jaw;

FIG. 4B is a side view of an appliance positioned between the upper and the lower jaw to reposition the mandible into an anatomically correct position;

FIG. 5A is a perspective view of the appliance with occlusal index material;

FIG. 5B is a side view of the use of the appliance with occlusal index material positioned in an upper and lower jaw;

FIG. 5C is a front view of the appliance with occlusal index material positioned in an upper and lower jaw;

FIG. 6A is a top view of a bite guide;

FIG. 6B is a bottom view of a bite guide;

FIG. 7A is a side view of a bite guide for a Class 1 occlusion;

FIG. 7B is a side view of a bite guide for a Class II occlusion;

FIG. 8A is a perspective view of an alternative embodiment of a repositioning appliance;

FIG. 8B is a posterior view of an alternative embodiment of a repositioning appliance; and

FIG. 8C is a front view of an alternative embodiment of a repositioning appliance.

### DETAILED DESCRIPTION OF THE INVENTION

A mandible repositioning appliance 10 is provided that may be adapted for use on the lower jaw or for use on the upper jaw. In either case, the appliance includes an anterior (front) portion 22 adapted to engage or receive anterior teeth and first and second posterior (rear) portions 24a/24b (lower member), each adapted to engage or receive one or more posterior teeth.

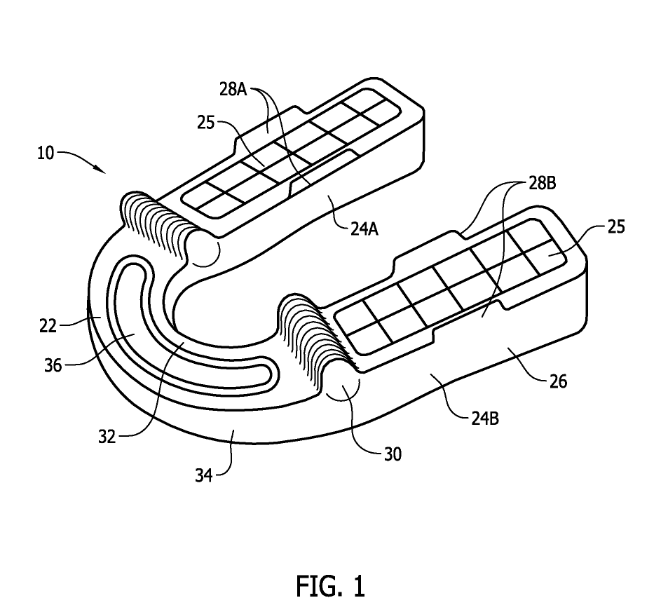

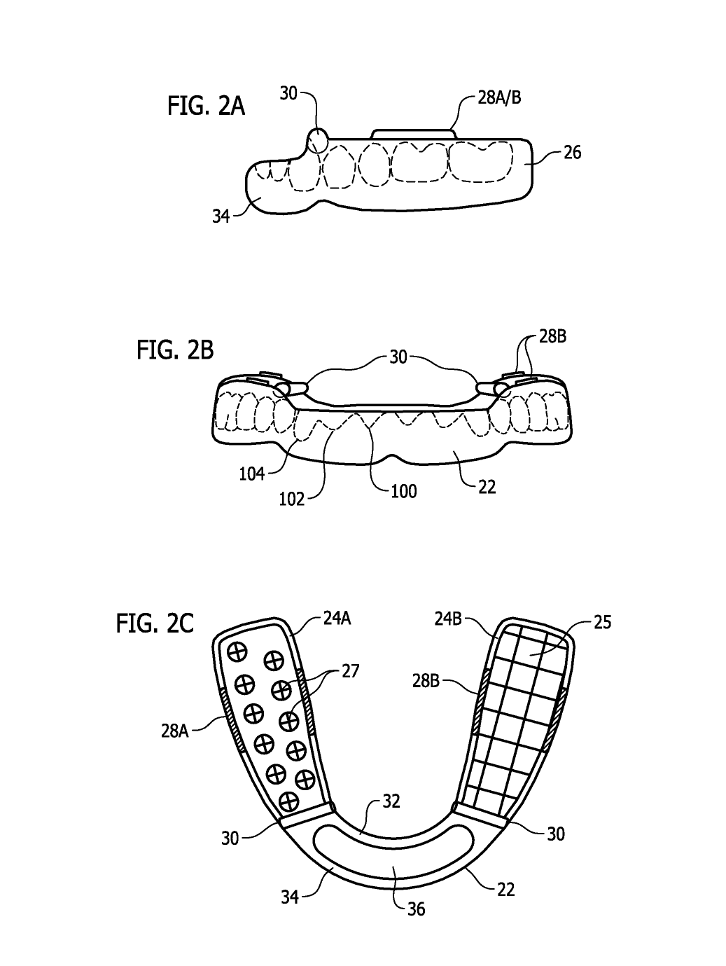

A repositioning appliance 10 for use on a lower jaw (a lower appliance) is illustrated in FIG. 1. The anterior portion 22 of the appliance connects to, or may comprise means which connect, the first posterior portion 24a and the second posterior portion 24b. In one embodiment the anterior portion is adapted to accommodate anterior teeth. As shown in FIG. 1, the anterior portion 22 may comprise a lingual connector 32 and a buccal connector 34 to connect the first posterior portion 24a to the second posterior portion 24b. In one embodiment, the buccal connector is notched to accommodate any labial frenum attachment to provide relief from any impingement. In this embodiment, a curved opening 36 exists in between each of the connectors sufficient to receive anterior teeth, e.g. the incisors and cuspid teeth at positions 100, 102 and 104 on both sides as shown in FIG. 2. However, as one of skill in the art will appreciate, the anterior portion 22 may comprise a lingual connector 32 only, or a buccal connector 34 only. In a further embodiment, the space between the lingual connector 32 and buccal connector 34 may instead form an enclosed tooth-receiving channel. Such a channel would be advantageous during athletic activity to prevent the striking of upper and lower anterior teeth, and thereby minimize impact to the lower jaw, and to allow the flow of air into the mouth. The channel may also be filled with or contain index material.

The posterior portions 24A, 24B of the appliance comprise an occlusal pad surface 25 and vertical flanges 26 supporting the surface 25. The vertical flange 26 can be located on the buccal aspect only or the lingual aspect only, or both simultaneously. The vertical flanges 26 extend upward or downward from the occlusal pad surface 25. The surface 25 may be any surface suitable for adhering to a registration material. The surface 25 may also be the registration material. The term registration material may be used interchangeably with the term index material. The surface 25 may be in the form of a mesh as shown in FIG. 1, or may be a support incorporating a plurality of apertures 27 as shown in FIG. 2C. A pair of rails 28A, 28B are formed along the lingual and buccal edges of the support 25 to contain the registration material within the surface 25. The rails 28A, 28B may be of various sizes and shapes, as one of skill in the art will appreciate, which maintain functionality and comfort for the user. As shown in FIG. 1, the rails 28A, 28B are approximately centrally located on the edges of surface 25 and extend about 5-15 mm in length. The surface 25 may be with no apertures to form the adaptable posterior occlusal pads and not require the use of a bite registration material. In this instance no vertical rails as shown in 28A, 28B are not necessary. In other embodiment the rails may extend or be different lengths or heights to accommodate protection of the teeth and containment of the registration material. The vertical flange 26 can be part or extend to form the rails 28A, 28B.

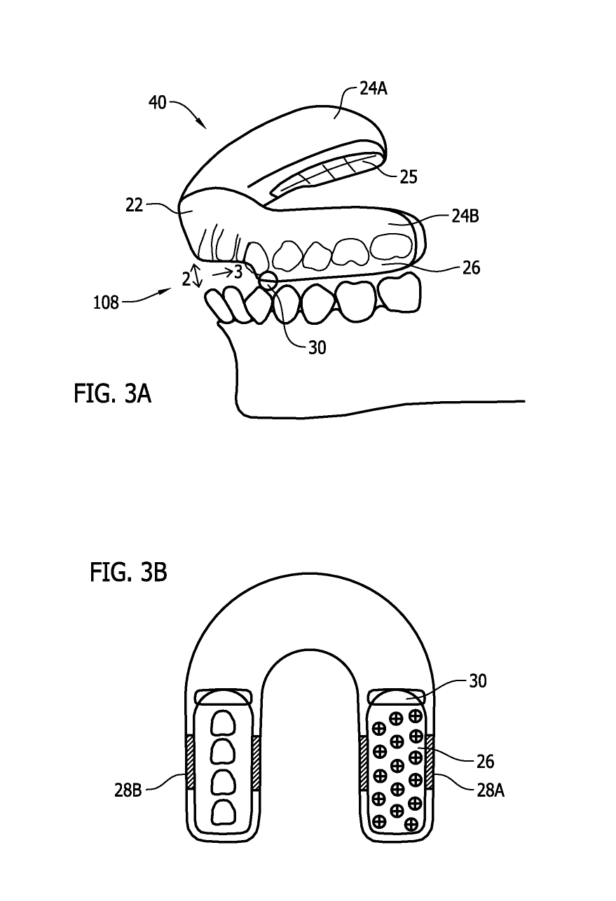

An appliance for use on the upper jaw may be structured similar to the appliance for use on the lower jaw, as shown in FIG. 3 or be formed integral with the lower jaw appliance. The anterior portion 22, may also comprise buccal and/or lingual connectors, or an enclosed channel sufficient to receive anterior teeth, e.g. the incisors and cuspid teeth at positions on both sides, and is shaped to provide an airway opening 108 of about 2-3 mm. An enclosed channel, as discussed above, may provide protection to teeth and soft tissues as well as forming a barrier to prevent contact of upper and lower teeth. The posterior portions 24A, 24B of the upper appliance 40 also comprise an occlusal pad surface 25 in the form of mesh, apertures or other surface appropriate to retain registration material, and vertical flanges 26 supporting the surface 25. The surface 25 may be with no apertures to form the adaptable posterior occlusal pads and not require the use of a bite registration material. In this instance no vertical rails as shown in 28A, 28B are not necessary.

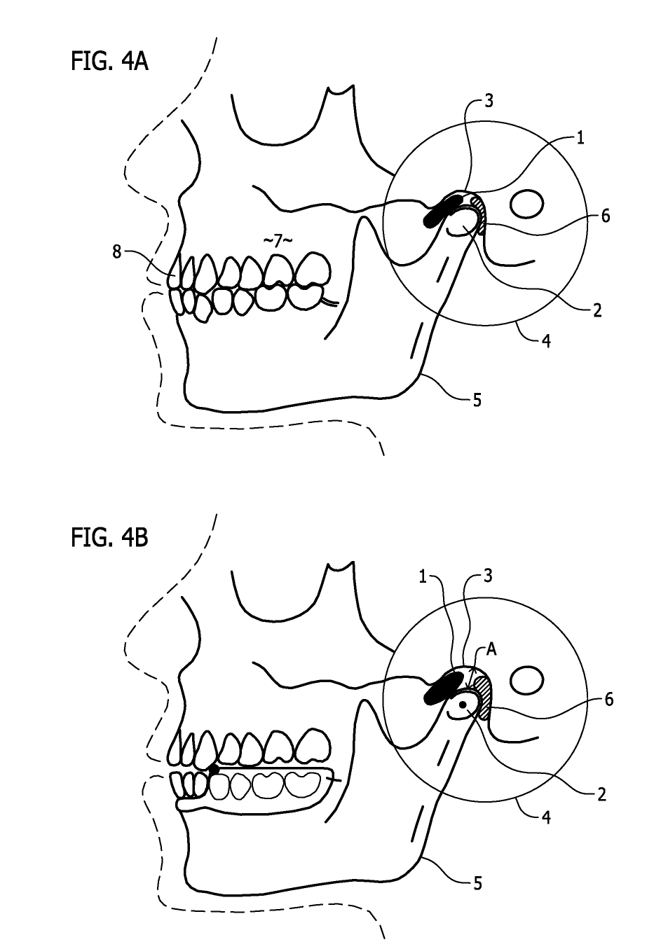

In reference to FIGS. 1, 2 and 3, in an appliance for use in the upper or lower jaw, a pair of positioning guides 30 integrally formed between the anterior portion 22 and each of the first and second posterior portions 24A, 24B. The guide 30 functions to position the mandible in a desired anatomically correct position to achieve optimal positioning of the temporomandibular joint, e.g. the condyles within the articular discs as shown in FIG. 4b. The positioning guide 30 is shaped to sit within the embrasure space between the cuspids, teeth 13, 23, 33 and 43 in the Palmer System or teeth 6, 11, 22 and 27 in the Universal System (position 3) and first bicuspids 14, 24, 34 and 44 in the Palmer System and 5, 12, 2l and 28 in the Universal System (position 4) of either the upper jaw (maxilla) or lower jaw (mandible) on both sides of the jaw. Thus, the positioning guide 30 may be any shape suitable for this purpose, for example, round, oval, octagonal, square, triangular or diamond in cross-section. In addition, the guide 30 will be of a size suitable to sit within the target embrasure space, and may typically have a diameter within a range of between about 1.5 to 7 mm. The size (diameter range) and shape of the guide 30 is selected based on the individual patient receiving the appliance and the unique attributes of the patient jaw, fossa, articular disk, condyle, and overall TMJ arrangement. It is contemplated that any known method selecting the correct size guide 30 may be utilized including known measurement technique or through the use of professional fitment by medical personal.

A repositioning appliance 10 in accordance with the invention may be made using techniques and materials known in the art. For example, an appliance 10 for use on either the upper or lower jaw may be made using a standardized mold that may be of various sizes to fit different-sized users. Hence, the mold may be made in a number of different sizes, such as different depths and widths while the index material could be custom molded to the patient's teeth and jaw position. The appliance may be made of materials or combination of materials known for use in making such oral devices, including but not limited to, thermoplastics such as poly (vinyl acetate-ethylene) (PVC) copolymer clear thermoplastic and laminated thermoplastic, polyethylene (HDPE), polyurethane, polypropylene, santoprine, saturated elastomer base styrenic (SEBS), polycaprolactone (PCL), ethyl vinyl acetate (EVA), silicones, acrylics, polyvinysiloxane(PVS) materials and mixtures thereof. As one of skill in the art will appreciate, the appliance may also incorporate one or more additional components to provide the appliance with advantageous properties, for example, an antimicrobial component to render the appliance more sanitary for use.

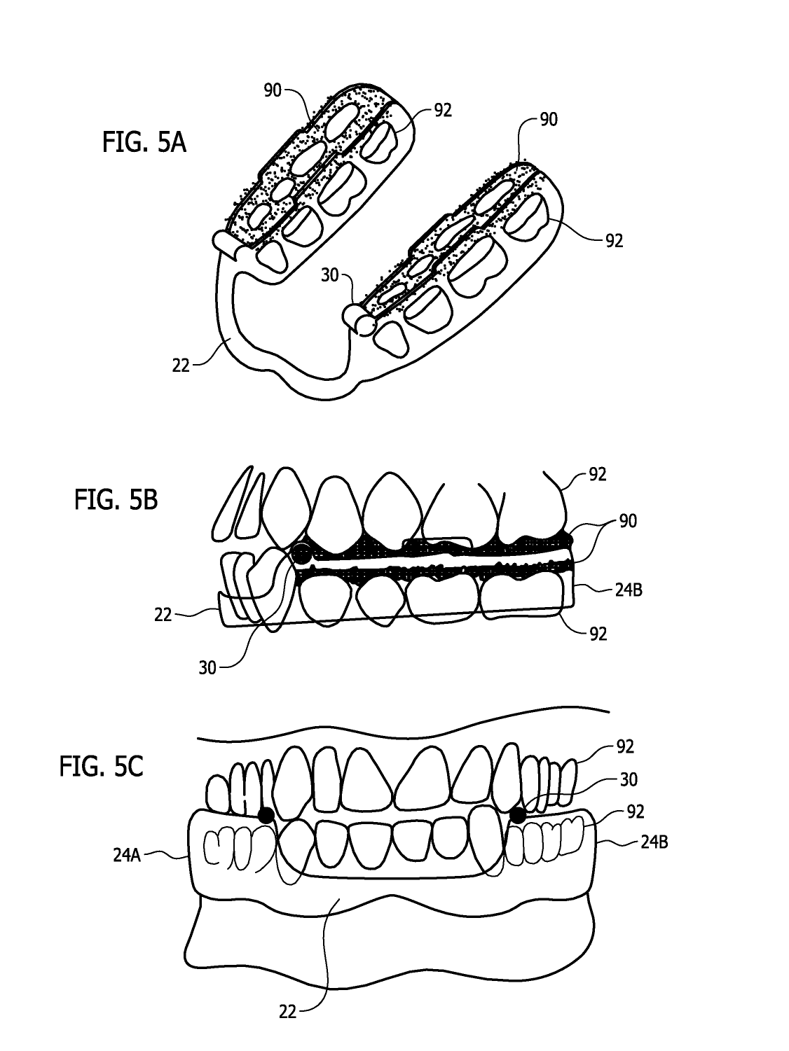

To prepare a repositioning appliance 10 in accordance with the invention for use, registration material is applied to the occlusal pad surfaces 25 of the posterior portions as shown in FIG. 5A. The registration material may be part of the appliance and adapted to be molded, such as through application of heat, or added, such as by injection or spreading, during the fitment process. The registration material may be any biocompatible material generally used for oral appliances which can be made pliable to permit moulding by a user on application of a stimulus (e.g. heat) and then maintains its shaped on cooling. Examples of such materials include, but are not limited to, polyvinyl siloxane (PVS), a thermoplastic material such as EVA or a hard acrylic. The selected registration material is softened to a form easily applicable to the appliance, e.g. generally by kneading it or similar action. Registration material can also be extruded from a tube through a mixing tip. Softened registration material is then applied to the occlusal pad surface 25 of the posterior portions 24A and 24B of the appliance in an amount sufficient to impregnate the surface 25 and also an amount sufficient to bilaterally engage both the upper and lower posterior teeth, e.g. an amount in the range of about 1-5 mls. The appliance is then placed in position in the mouth of the user in which the positioning guides 30 are seated within the embrasure space between the cuspids (position 3) and the bicuspids (position 4) of either the upper jaw (maxilla) or lower jaw (mandible) on both sides of the jaw. The user (patient) then bites as shown in FIG. 4B, 5B, 5C in the desired anatomically correct mandibular position such that the positioning guides 30 are positioned between the cuspids (position 3) and the bicuspids (position 4) of the upper and lower jaws. FIG. 5B illustrates the anterior portion 22 in relation to the anterior (front) teach. Registration material 90 is placed on or formed as part of the accusal pad surface 25, such as on the top surface, bottom surface or both. The bite results in engagement of the registration material 90 on the posterior portions 24A, 24B with the upper and lower posterior teeth (e.g. bicuspids and molars). The bite is held until the registration material 30 sets. Actions may be taken to hasten the setting of the material, such as use of cool water. The appliance is then removed from the user's mouth to yield a customized appliance including a posterior portion with an occlusal pad (including registration material) that specifically engages the posterior teeth of the user and which has captured the desired correct occlusion position that positions the condyles in a neutral unstrained anatomical position. It is noted that the occlusal pads (or formed registration material) may be raised or lowered to maintain the separation of the teeth during impact, if the appliance is used in a contract sport. The positioning guide 30 may be left as part of the appliance to establish and maintain the proper positioning of the mandible or removed to establish fit based on the bite registration. Through use of the pads surfaces 25 and positioning guide 30, connected by the anterior connector 22, the registration material may be placed on the surfaces of the pads prior to insertion into the patient's mouth thereby eliminating the drawbacks of the prior art when attempting to create molds. FIG. 5C illustrates a front view of the appliance fitted in the patient's mouth. As shown, the teeth are shown as well as the front anterior portion 22 with the positioning guides 30 along with the posterior portions 24A, 24B.

In one example embodiment, when preparing a repositioning appliance in accordance with the invention, an oral splint for this purpose, such as an Aqualizer™, may be simultaneously applied in a known manner. With respect to the use of an oral splint, it is important to achieve an appropriate degree of clearance between the anterior teeth, e.g., a distance of about 1-3 mm. between the upper incisal edges and the lower incisal edges. In this regard, the oral splint, e.g. Aqualizer, is inserted in the mouth and facilitates positioning of the mandible in an anatomically correct position in which the condyles are positioned in a more downward and forward position and the TMJ joint has decompressed. The splint may or may not be used in combination with transcutaneous electrical neural stimulation (TENS). Following a sufficient period of time to achieve the desired position, the distance between the incisal edges of the upper and lower teeth is determined. For use of an upper appliance (on the upper jaw), a minimum clearance of approximately 3 mm between upper and lower incisors is desirable, while a minimum clearance of approximately 2 mm is desirable for use of a lower appliance (on the lower jaw). A vertical CEJ to CEJ should be approximately 17 to 20 mm CEJ refers to cemento-enamel junction, e.g. the junction at which enamel ends and cementum begins on the tooth and is typically measured between corresponding upper and lower central incisors). In the event that insufficient clearance or inadequate vertical dimension exists, bite registration material may be applied to achieve the appropriate clearance. In this regard, registration material is placed within the anterior region, anterior to the splint, e.g. Aqualizer pads, and onto the incisal edges and cusp tips of the cuspids and premolars. The patient's mouth is then closed slowly to the desired clearance and vertical dimension while the splint is in place. As above, when the registration material is set, the appliance is removed.

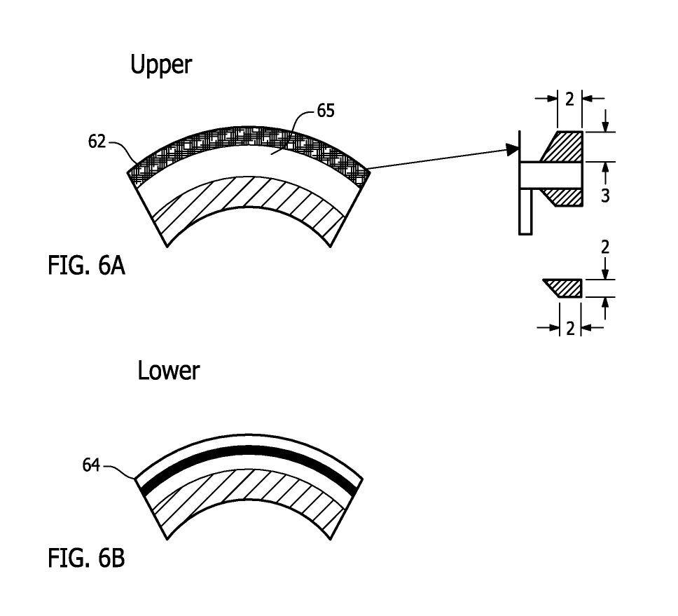

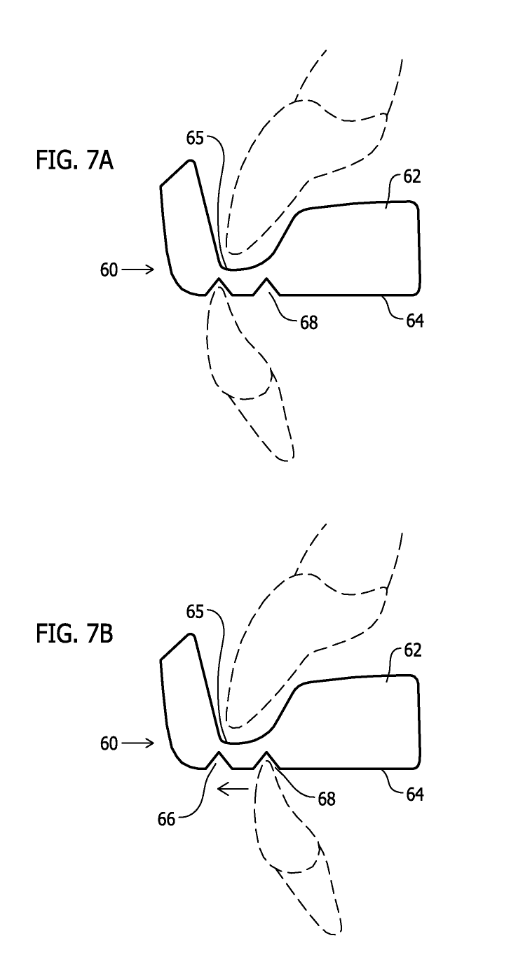

FIGS. 6A and 6B is a top and bottom view of a bite guide while FIG. 7A & 7B is a side view of a bite guide for a Class I occlusion and a class II occlusion. Alternatively, a bite guide 60 as shown in FIGS. 6 and 7 may be utilized to facilitate achieving the desired bite within the appliance. The bite guide is located at the front 22 of the appliance. The bite guide 60 may be made of a suitable plastic material, including thermoplastic material such as EVA, or an extruded polystyrene foam such as Styrofoam™. The bite guide 60 is generally curve-shaped for fitting between the anterior teeth, e.g. incisors, of a user, and may be sized for use by a child, youth or adult. The guide 60 comprises an upper face 62 and a lower face 64. The thickness of the guide 60 between the upper and lower faces 62, 64 may be in the range of about 6-15 mm. A groove 65 is formed in the upper face 62 of the guide 60 and is of a size and shape suitable to receive upper incisors. The depth of the groove 65 is generally in the range of about 4-8 mm.

In reference to FIG. 7, first and second notches 66, 68 are formed in the lower face 64, and may be equidistantly spaced from one another. The notches 66, 68 are also of a size and shape suitable to receive lower anterior teeth, e.g. incisors. The depth of each notch 66, 68 is generally in the range of about 1-2 mm. The thickness of the guide 60 between groove 65 and notches 66, 68 will generally be about 1.5-3 mm. The groove 65 and the first notch 66 are aligned such that placement by a user of their upper anterior teeth in the groove 65 and lower anterior teeth in the first notch 66 results in the desired anatomical positioning of the mandible. The grooves and notches establish and help maintain the desired positioning of the jaw.

The lower anterior teeth are placed in the first notch 66 when the user has a Class I occlusion (e.g. ideal bite in which the upper mesial buccal cusp of the first molar lines up with the buccal groove of the lower first molar), and depending on the user's centric occlusion overjet, may result in an advancement of 1 to 4 mm of the lower jaw forward. For user's having a Class II occlusion (e.g. a bite in which the mesial buccal cusp of the upper first molar is anterior to the buccal groove of the lower molar, and an overjet of 3-5 mm or more), lower anterior teeth are place in the second notch 68 due to the fact that use of the first notch 66 would result in uncomfortable advancement of the lower jaw.

In another aspect, a kit is provided. The kit comprises at least one of a mandible repositioning appliance in accordance with the present invention for use on the upper or lower jaw, or both. The kit will additionally include registration material for use to prepare the occlusal pad thereof. The registration material may be provided in unapplied form, or may be provided already applied and impregnated within the occlusal pad surface 25 of the appliance. The kit may additionally include instructions for applying the registration material to the occlusal pad surface, or instructions for preparing the repositioning appliance for use. In this regard, and to assist with the preparation of the appliance to include an appropriately positioned bite, a bite guide as previously described may also be included.

As one of skill in the art will appreciate, the present repositioning appliance may be used to address various issues related to the positioning of the jaws. It is useful to address conditions associated with derangement of the temporomandibular joint (such as clicking, popping, crepitus, limited opening, pain, tinnitus, ear congestion, vertigo and tingling in the finger tips, migraines, headaches, neck and shoulder pain). It may also be usefully applied by athletes to improve athletic performance, and to mitigate mild traumatic brain injury or concussion. By repositioning the condyles relative to the articular discs in a more anatomically ideal position, the discs function as shock absorbers, formed mainly out of dense fibrocartilagenous material, thereby reducing the impact of the condyles against the base of the mandibular fossa. Placement of the condyles in this position (e.g. a downward and forward position), increases the distance between the condyles and the base of the mandibular fossa, so that the condyles must travel a greater distance before striking the mandibular fossa, further minimizing the effect of impact to the lower jaw. This reduces the likelihood a shock or vibration being transferred to the brain or skull. In addition, placement of the condyles in this position typically places them a thicker portion of bone along the anterior eminence of the fossa where absorption of forces from impact is greater.

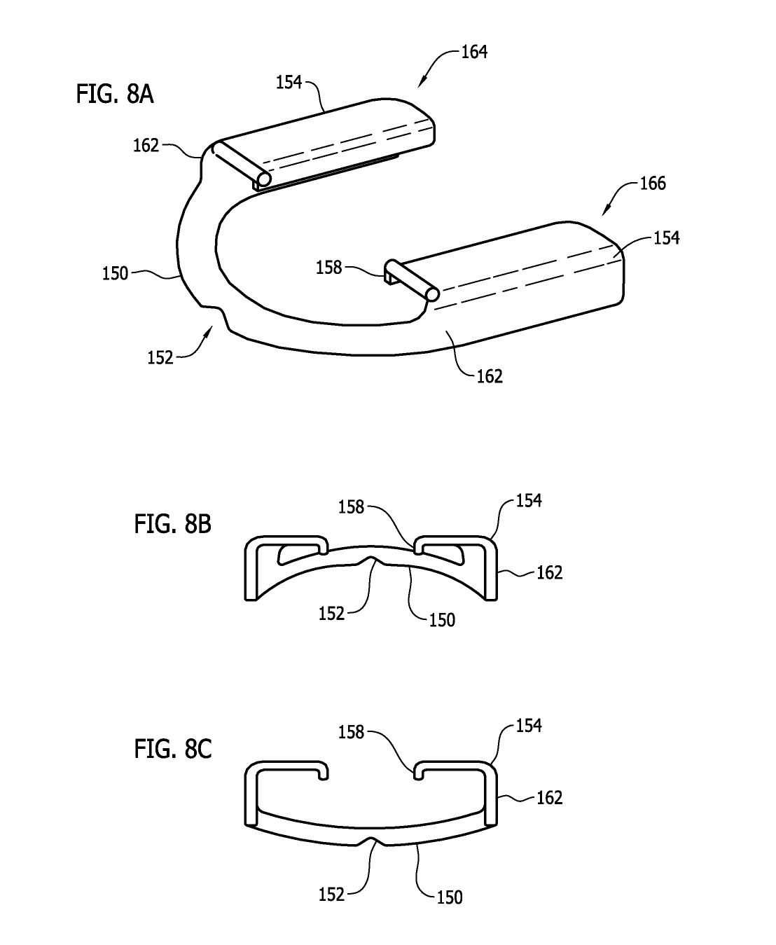

FIGS. 8A, 8B, and 8C is a perspective view of an alternative embodiment of a repositioning appliance. In this alternative embodiment an anterior portion 150 includes an indent 152 providing a labial frenum relief. The posterior portions 154 may include one or more ridges or shelves 158 to contain the registration material (not shown). In addition, instead of the anterior portion 150 connecting in the same general plane as the occlusal supports pads of FIG. 1, the anterior portion 150 may connects to the side vertical flanges 162. The posterior end of the posterior portions 154 may be rounded 164 or square 166. FIG. 8B illustrates a posterior view of the alternative embodiment of a repositioning appliance.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

1. A mandible repositioning appliance for use to reposition the mandible of a user comprising:
an anterior portion adapted to receive anterior teeth;
first and second posterior portions connected by the anterior portion, each posterior portion adapted to receive posterior teeth, wherein each posterior portion comprises an occlusal pad support; and
a positioning guide formed between the anterior portion and each of the first and second posterior portions, wherein said guide functions to position the user's mandible into an anatomically correct position achieved when each positioning guide is in position resting between the third and fourth upper and lower anterior teeth when the appliance is in place in the user's mouth.

2. The appliance of claim 1 further comprising a registration material on the first and second posterior portions.

3. The appliance of claim 2 wherein the registration material is on the occlusal pad support of each posterior portion.

4. The appliance of claim 1 wherein the occlusal pad support is formed from a registration material.

5. The appliance of claim 4 wherein the registration material is molded by application of heat which softens the registration material.

6. The appliance of claim 1 wherein the position guide has a height which separates the upper and lower anterior teeth.

7. The appliance of claim 1 further comprising a shelf extending from the occlusal pad support.

8. The appliance of claim 1 wherein the anterior portion comprises a lingual connector and a buccal connector which connect to the first posterior portion and the second posterior portion to form a curved opening between the lingual connector and a buccal connector to receive anterior teeth.

9. A kit useful for mandible repositioning comprising:
i) a mandible repositioning appliance comprising an anterior portion adapted to receive anterior teeth, a first and second posterior portion each adapted to receive posterior teeth of a patent, wherein each posterior portion comprises an occlusal pad support; and a positioning guide formed between the anterior portion and each of the first and second posterior portions, wherein said guide functions to position the patient's mandible into an anatomically correct position achieved when each positioning guide is in position resting between the third and fourth upper and lower anterior teeth when the appliance is in place in the patient's mouth; and
ii) registration material for use in making an occlusal pad in each occlusal pad support.

10. The kit of claim 7, wherein the occlusal pad support includes a mesh or a plurality of apertures configured to hold the registration material when the registration material is applied to the occlusal pad support.

11. The kit of claim 7, wherein the positioning guide, which is cylindrical in shape, is associated with each occlusal pad support, and extends across each occlusal pad support.

12. The kit of claim 7, wherein a size is associated with the kit and the size corresponds to the size of the appliance, to thereby adapt the kit to the position of the patient's mandible.

13. A method of making a mandible repositioning appliance:
providing an appliance having an anterior connector which attaches to a first occlusal pad supports which is part of a first posterior portion and second occlusal pad supports which is part of the a second posterior portion of the appliance such that the occlusal pad supports have a registration material;
placing the appliance in position in a user's mouth so that the positioning guides are seated between the third and fourth anterior teeth and one or more teeth of the user contact the registration material;
moving the user's mandible toward the user's upper jaw such that the positioning guides are enclosed within the space between the upper and lower third and fourth anterior teeth to apply pressure to the registration material to form a mold of one or more posterior teeth of the user; and
maintaining position of the user's mandible until the registration material sets to form occlusal pads in the posterior portions which conform to one or more posterior teeth of the user to thereby maintain the user's mandible at a position defined by the positioning guides.

14. The method of claim 12, wherein moving the user's mandible toward the user's upper jaw is done by the user or by a dental technician.

15. The method of claim 13, wherein providing an appliance with the registration material comprises applying a registration material to the first and second occlusal pad supports of the first and second posterior portions of the appliance, such that the registration material is mixed or extruded from one or more tubes.

16. The method of claim 13, wherein providing an appliance with the registration material comprises heating the registration material to soften the registration material.

17. The method of claim 16, further comprising having the user drink cold liquid to set the registration material when maintaining position of the user's mandible.

18. The method of claim 17, further comprising having the user move the user's mandible to verify the reproducibility of a fitment and if necessary reheat the registration material and repeat the process.

19. The method of claim 13, wherein the appliance further comprises a curved opening in the anterior connector and the method further comprises providing registration material in the anterior connector such that movement of the user's mandible causes one or more anterior teeth of the user to contact and mold the registration material in the anterior connector.
